(19) United States
(12) Patent Application Publication
(10) Pub. No.: US 2009/0146835 A1
(43) Pub. Date: Jun. 11, 2009

(54) WIRELESS COMMUNICATION FOR DOWNHOLE TOOLS AND METHOD

(75) Inventors: Yang Xu, Houston, TX (US); Ziping Hu, Katy, TX (US)

Correspondence Address: CANTOR COLBURN, LLP, 20 Church Street, 22nd Floor, Hartford, CT, 06103, US

(73) Assignee: BAKER HUGHES INCORPORATED, HOUSTON, TX (US)

(21) Appl. No.: 12/164,541

(22) Filed: Jun. 30, 2008

Related U.S. Application Data
(60) Provisional application No. 60/992,490, filed on Dec. 5, 2007.

(51) Int. Cl. G01V 3/00

(52) U.S. Cl. 340/854.3

(57) ABSTRACT

A system for setting a tool in a downhole environment includes a communicator configured to broadcast a signal; a downhole tool configured to receive the signal from the communicator and execute on an instruction conveyed by the signal, a radio wave inhibiting structure being interposed between the communicator and the downhole tool and method.

### CROSS REFERENCE TO RELATED APPLICATION

The present application claims priority to U.S. Provisional Patent Application Ser. No. 60/992,490, filed Dec. 5, 2007, the entire contents of which are specifically incorporated herein by reference.

### BACKGROUND

Many tools in the downhole industry are actuated by other tools that are “run in the hole” for just that purpose. This implies, and often is the case, that an extra step in well production is necessary. In order to reduce the number of runs and therefore reduce costs of building and running a well system, the art has been provided with and still actively seeks additional means for actuating downhole tools that do not require separate runs or at least can increase the functionality of each particular run. Moreover, many downhole tools require openings through the casing wall to allow actuations to occur. While this method is well tried and true, there are drawbacks to such tools having an opening in the casing or other tubular structure to which the specific tool is mounted. Such drawbacks include but are not limited to the potential for a leak path through the opening. The art would well receive a system that avoids such openings.

### SUMMARY

A deliverable downhole communicator including a shaped object; and a communication medium emitter in contact with the object, the emitter emitting a signal capable of passing through a radio wave inhibiting structure.

A system for setting a tool in a downhole environment includes a communicator configured to broadcast a signal; a downhole tool configured to receive the signal from the communicator and execute on an instruction conveyed by the signal, a radio wave inhibiting structure being interposed between the communicator and the downhole tool.

A method for communicating with a downhole tool includes delivering a communicator to a position proximate a downhole tool; and emitting a signal from the communicator receivable by the downhole tool through a radio wave inhibiting structure without an opening therein for passage of radio waves.

### BRIEF DESCRIPTION OF THE DRAWINGS

Referring now to the drawings wherein like elements are numbered alike in the several Figures:

FIG. 1 is a schematic cross-sectional representation of a wellbore illustrating a communicator as disclosed herein; and

FIG. 2 is a schematic representation of a packer responsive for actuation to the communicator illustrated in FIG. 1.

### DETAILED DESCRIPTION

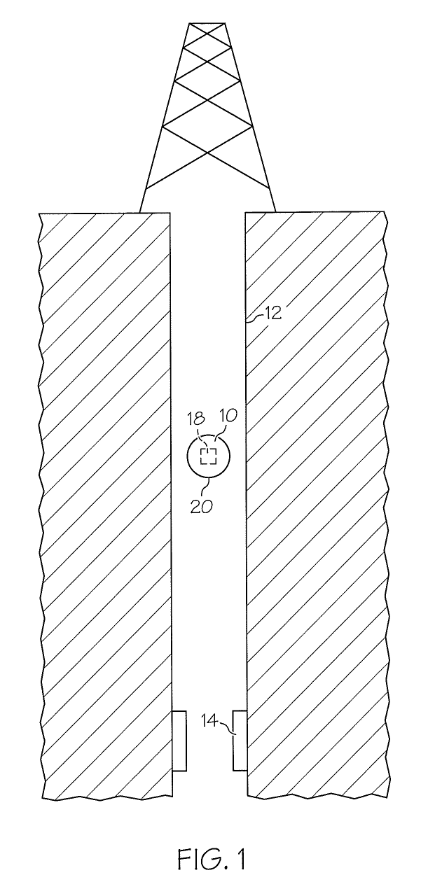

Referring to FIG. 1, a deliverable downhole communicator 10 is illustrated during its trip down a wellbore 12 to a target device 14 in the downhole environment. The communicator 10 as illustrated is an independent device that is capable of being pumped, dropped, lowered, etc. into the downhole environment. The communicator 10 harbors a communication medium (signal) emitter 16 somewhere within or on the surface of the communicator 10 that is capable of broadcasting a signal such as an acoustic signal, a magnetic field, a gamma wave signal, a recording (even voice), etc. The signal may be continuously broadcast, on a timer, may begin at a selected depth, may begin when contact is made with a certain chemical, when another field is encountered, upon receiving a certain start (or stop) signal (assuming that the communicator utilizes a transceiver or includes a separate receiver) and could be configured to operate utilizing a combination of these or combinations including at least one of the foregoing. In any event, the communicator utilizes a wireless signal to communicate instructions to a downhole tool while not requiring a high output as might otherwise be required due to the distance norms associated with wireless downhole communication systems. The communicator 10 in one embodiment will include an on board power source to drive the signal emitter 16. The source may be a battery or may be a pressure based energy source or electrochemically based energy source. It is, of course, possible to power the communicator from the surface if indeed it is tethered in some way thereto such as on slickline or wireline, etc.

In embodiments where the power source is on board allowing the communicator to be completely self contained the configuration of the communicator may be in that of a ball, a dart, a rotary wing with a gravity pendant, etc. In some instances, it may be desirable to slow the descent of the communicator into the downhole environment. This can be done effectively with: the rotary wing embodiment and is adjustable depending upon the angle of the wing, a parachute attached to any of the configurations of the communicator 10, a selection of the density of the communicator 10 relative to the density of the fluid in the hole, etc.

In each case, the communicator 10 is moved or allowed to move through the wellbore 12 and as it does so it will communicate its instructions to a target downhole tool. This can occur by the communicator continuously emitting a signal that is recognized by a target downhole tool as the communicator passes that tool. The result then is that the downhole tool will do whatever it was programmed to do upon receiving the signal. This could be the inflation of a packer, firing of a perforating gun, actuating of a sleeve, or any other operation desired. As noted, the mode of operation of the communicator can also be intermittent based upon any of the foregoing listed factors. In such embodiments, the communicator will begin to emit at a selected time such that the downhole target tool will be able to receive the signal.

In one embodiment contemplated herein, each communicator 10 will have a specific communication medium or frequency such that it controls only one downhole tool. Such a condition will ensure selective actuation of selected downhole tools only. In other contemplated embodiments, the communicator will utilize a spread spectrum frequency (a minimum of two frequencies or two communication mediums) such that a number of downhole tools may be addressed in a single “run” of the communicator. In this condition, different frequencies or communication mediums will commence at the same time, the target downhole tools effectively identifying themselves by responding to only one of the frequencies or communication mediums while other tools will respond to other of the signals. It will be understood in view of other teachings herein however that the spread spectrum may not require that the different frequencies/mediums begin emitting at the same time but rather that they may begin at different times upon impeti as noted above.

Further, it is contemplated that the communicator 10 may be responsive to a response signal from one or more of the downhole tools with which it becomes proximate, for example, to change the frequency at which it is operating to ensure that the next addressed downhole tool is actuated only if the first addressed downhole tool responds to the communicator's signal, thereby changing the frequency of the communicator's signal.

Recordation playback, as noted above, can include any type of signal desired but the use of the recordation playback embodiment allows communicators to be manufactured as blanks and then set to perform the desired task at the well site. Such recordation playback embodiments can even utilize voice recordings for specific instructions to downhole tools providing that the downhole tools are configured with voice recognition software similar to that used for computer dictation or telephone operator assistance.

Regardless of the specific configuration of the communicator 10, it is axiomatic that the signal emitter 18 will require protection in the downhole environment. Such protection can be supplied by embedding or enveloping the signal emitter within the communicator shell 20 or by mounting the emitter on the surface of the communicator shell 20 if the emitter is appropriately constructed for this location.

Referring to the shell 20 of the communicator 10, it is to be appreciated that the material of the shell 20 may be of many types of material. The material must be transmissive to the communication medium being employed and be sufficiently durable to endure the downhole environment for long enough to accomplish its mission. Beyond these requirements though, in some embodiments it is desirable to construct the communicator from dissolvable material so that over a period of time longer than its intended useful life, it will dissolve in wellbore fluids thereby not being an impediment to any other downhole operations. Alternatively, the communicator may be constructed of an easily drillable material so that regardless of the fact that it will remain in the wellbore, any further drilling operations will be unaffected by the communicator.

The communicator 10 as described above is particularly useful in one embodiment to actuate downhole tools that do not include any openings through the casing wall. As will be recognized by one of ordinary skill in the art, technologies such as RFID require an opening in the casing to allow the radio waves emitted thereby to escape the metal casing and reach the tool to be actuated. Since this is a potential leak path, it is undesirable. In one embodiment of the communicator 10, acoustic energy is used and thus requires no opening in order to penetrate the casing wall.

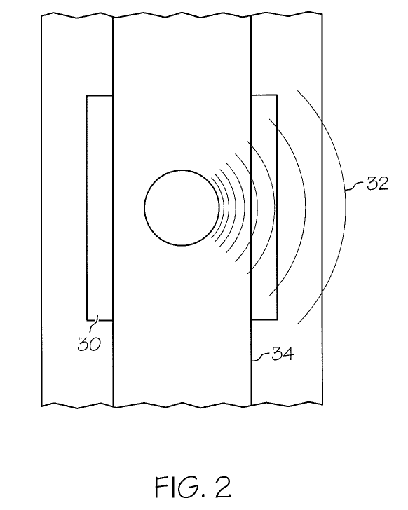

In one embodiment, the tool is a packer 30, see FIG. 2, and the communicator is a ball type communicator that is in the process of being pumped or allowed to fall to or through proximity with the packer 30. The acoustic signal 32 is illustrated emanating from the communicator 10. As the acoustic signal will pass through the casing 34, the signal has no difficulty reaching the packer 30 and providing whatever instructions are needed for the packer to take appropriate action.

The packer 30 in one embodiment includes its own setting force arrangement. This may be a gas generation system that is actuated by the acoustic signal or may be an electrical setting system actuated by the acoustic signal (or other communication medium). In such case, the packer may be set in response to the acoustic signal being received thereby when the communicator 10 reaches proximity with the packer 30. this is accomplished without the need for an opening and therefore the avoidance of a potential leak path.

While preferred embodiments have been shown and described, modifications and substitutions may be made thereto without departing from the spirit and scope of the invention. Accordingly, it is to be understood that the present invention has been described by way of illustrations and not limitation.

1. A deliverable downhole communicator comprising:
a shaped object; and
a communication medium emitter in contact with the object, the emitter emitting a signal capable of passing through a radio wave inhibiting structure.

2. The communicator as claimed in claim 1 wherein the medium is acoustic energy.

3. The communicator as claimed in claim 1 wherein the medium is a magnetic field.

4. The communicator as claimed in claim 1 wherein the medium is gamma energy.

5. The communicator as claimed in claim 1 wherein the medium is a voice recording.

6. The communicator as claimed in claim 1 wherein the object is a ball.

7. The communicator as claimed in claim 1 wherein the object comprises a dissolvable material shell.

8. The communicator as claimed in claim 1 wherein the emitter emits the selected medium continuously.

9. The communicator as claimed in claim 1 wherein the emitter emits the selected medium discontinuously.

10. The communicator as claimed in claim 10 wherein the emitter emits pursuant to a timer.

11. The communicator as claimed in claim 10 wherein the emitter emits pursuant to contact with a particular chemical.

12. The communicator as claimed in claim 10 wherein the emitter emits pursuant to being exposed to a selected pressure.

13. The communicator as claimed in claim 1 wherein the emitter emits at least two frequencies or at least two mediums.

14. The communicator as claimed in claim 1 wherein the communicator is untethered to a remote location associated with a well in which the communicator is deployed.

15. The communicator as claimed in claim 1 wherein the communicator includes a recordation playback configuration.

16. The communicator as claimed in claim 1 wherein the recordation playback configuration is a voice recordation playback device.

17. A system for setting a tool in a downhole environment comprising:
a communicator configured to broadcast a signal;
a downhole tool configured to receive the signal from the communicator and execute on an instruction conveyed by the signal, a radio wave inhibiting structure being interposed between the communicator and the downhole tool.

18. The system as claimed in claim 18 wherein the downhole tool further includes its own power source for executing on instructions received from the communicator.

19. A method for communicating with a downhole tool comprising:
delivering a communicator to a position proximate a downhole tool; and
emitting a signal from the communicator receivable by the downhole tool through a radio wave inhibiting structure without an opening therein for passage of radio waves.
